(19) United States
(12) Patent Application Publication
(10) Pub. No.: US 2021/0007536 A1
(43) Pub. Date: Jan. 14, 2021

(54) COLD BREW COFFEE APPARATUS

(71) Applicant: Formula 133, LLC, Coeur d'Alene, ID (US)

(72) Inventor: Christian Pratt Nicastro, Coeur d'Alene, ID (US)

(73) Assignee: Formula 133, LLC

(21) Appl. No.: 16/509,750

(22) Filed: Jul. 12, 2019

(51) Int. Cl. A47J 31/06; A47J 31/44; A47J 31/46; A23F 5/26

(52) U.S. Cl. CPC A47J 31/0663; A23F 5/26; A47J 31/46; A47J 31/446

(57) ABSTRACT

A brewing apparatus including a group head and a portafilter shaped to engage the group head such that the group head forms a seal on the portafilter when the portafilter is in a locked position within the group head. The brewing apparatus further including a first vessel in fluid communication with the group head and a second vessel in fluid communication with the group head. The brewing apparatus also includes a vacuum pump configured to pump fluid from the first vessel through the group head and the portafilter and into the second vessel.

### BACKGROUND

Coffee is one of the oldest and most widely used commodities. As the coffee industry continues to morph and grow, so have the methods and devices that are used to brew coffee. When it comes to brewing coffee at hot and/or warm temperatures, there are countless ways by which coffee may be brewed. However, when brewing coffee at cold (or relatively cold/cooler) temperatures (also referred to in the industry as “cold brew”), there are limited methods and/or devices for brewing coffee. (Cold brew coffee is not to be confused with iced coffee, in which coffee is brewed hot (and/or warm) and ice is then provided to reduce the temperature of the coffee.) Typical cold brew methods involve steeping coffee grounds in water at room and/or cold temperatures for long periods of time (e.g., around 14-20 hours). As such, cold brew tends to be a long (often overnight) process. Furthermore, typical cold brew methods tend to produce high levels of waste due to the high ratio of coffee grounds to water. For example, some cold brew methods involve creating a concentrate cold brew that is then diluted when served. Described herein are improvements and technological advances that, among other things, advance the systems and/or methods for cold brew coffee.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the components on a larger scale or differently shaped for the sake of clarity.

FIG. 1 is a perspective view of a cold brew apparatus according to an embodiment of this disclosure.

FIG. 2 is a perspective view of a cold brew apparatus showing internal components of the cold brew coffee apparatus according to an embodiment of this disclosure.

FIG. 3A is a front view of a group head of a cold brew apparatus according to an embodiment of this disclosure.

FIG. 3B is a perspective view of a group head of a cold brew apparatus according to an embodiment of this disclosure.

FIG. 4 is a front view of a portafilter and a group head of a cold brew apparatus according to an embodiment of this disclosure.

FIG. 5 is a side view of a portafilter of a cold brew apparatus according to an embodiment of this disclosure.

FIG. 6 is a block diagram illustrating logical components of an example computing device of a cold brew apparatus according to an embodiment of this disclosure.

FIG. 7 is a flowchart illustrating an example process of brewing cold brew coffee according to an embodiment of this disclosure.

### DETAILED DESCRIPTION

As described previously, there is a plethora of methods and devices designed to brew coffee at warm temperatures (i.e., above ambient temperature). However, there are limited methods and devices for brewing coffee at relatively lower temperatures (i.e., at and/or below ambient temperature). Typical cold brew methods involve relatively high coffee to water ratios and require long steeping times to extract flavor compounds found in coffee beans.

This disclosure is directed to a coffee brewing apparatus and method thereof. More specifically, this discourse describes an a coffee brewing machine (also referred to herein as a “cold brew apparatus”) that brews coffee (or “cold brew” coffee) at relatively lower temperatures (i.e., at and/or below ambient temperature). The cold brew apparatus may be capable of brewing cold brew coffee in a fraction of time when compared to typical cold brew methods. The cold brew apparatus may also brew cold brew coffee with a reduced coffee to water ratio when compared to traditional steeping/soaking methods. For example, typical methods steep cold brew for about 14-20 hours or longer. In an embodiment, the cold brew apparatus described herein may be capable of brewing cold brew coffee in less than 10 minutes. Still further, in an embodiment, the cold brew apparatus may brew cold brew coffee in under 2 minutes.

In an embodiment, the cold brew apparatus may include a group head. The group head may be configured to receive a portafilter insertable therein. The portafilter of the cold brew apparatus may engage with the group head such that the group head forms an air tight seal on the portafilter. The cold brew apparatus may further include a first vessel for containing fresh water or cycled cold brew for recycling after a fluid cycle in the apparatus as described in detail herein. The first vessel is in fluid communication with the group head. In a first cycle of creating a cup of cold brew, the cold brew apparatus may pump water from the first vessel, into a top portion of the group head, through the portafilter (which may contain coffee grounds when brewing coffee), and out a bottom portion of the group head. Additionally, and/or alternatively, the cold brew apparatus may include a second vessel that is also in fluid communication with the group head. In an embodiment, once the water has passed through the group head and portafilter, the water, now cold brew, may then be stored in the second vessel. Furthermore, the cold brew apparatus may draw water through the portafilter under a vacuum. Additional details of the cold brew apparatus are described below with reference to the drawings.

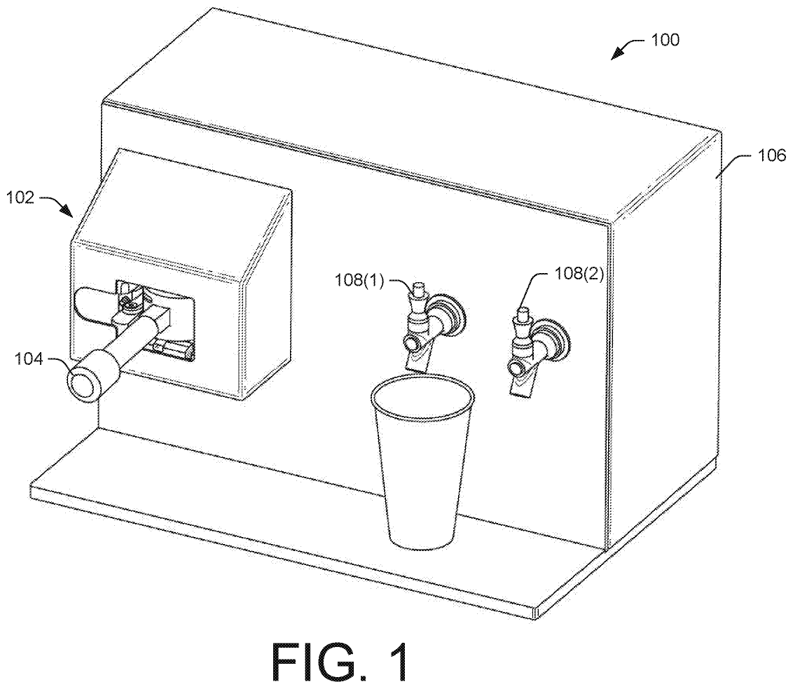

FIG. 1 illustrates a perspective view of a cold brew apparatus 100. As shown in FIG. 1, the cold brew apparatus 100 may include a group head 102 and a portafilter 104 (the portafilter 104 holding coffee grounds therein). In an embodiment, the cold brew apparatus 100 may include multiple group heads and corresponding portafilters. As described above and illustrated in FIG. 1, the portafilter 104 is shaped (described further herein below) to engage with the group head 102. In an embodiment, the portafilter 102 may be shaped such that the portafilter 102 may be inserted horizontally into the group head 102. Once inside the group head 102, the portafilter 102 may be rotated in a direction to lock into the group head 102 forming a seal on a top and bottom surface of the portafilter 104. The cold brew apparatus 100 may further include housing 106 that houses the internal components of the cold brew apparatus 100. The housing 106 of the cold brew apparatus 100 may be changed and/or designed based on the location and/or purchaser. For example, the cold brew apparatus 100 may be designed as an under-the-counter brewing machine or as a brewing machine that is designed to sit on top of a counter. Additionally, and/or alternatively, one or more features of the cold brew apparatus 100 may be configured to meet an end purchaser's specific configuration that is desired.

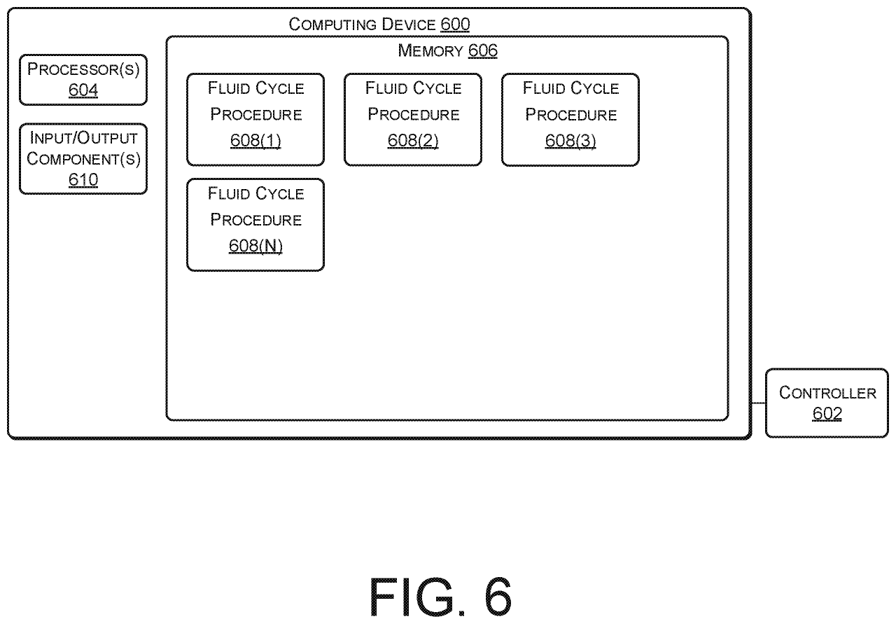

One or more computing devices may optionally be disposed in, on, or attached to the housing 106. However, in an embodiment, the one or more computing devices may reside elsewhere in the environment and be electronically coupled to the cold brew apparatus 100. Still further, the one or more computing devices may be entirely remote from the cold brew apparatus 100 and may communicate with the cold brew apparatus 100 via a network connection. This and other features of the one or more computing devices will be described further herein below with respect to FIG. 6. In an embodiment, the cold brew apparatus 100 may include a display screen disposed on the housing 106 and/or elsewhere in the environment. The display screen may include a user-interface (UI) that may provide information and/or analysis of the brewing process. Furthermore, the display screen may display cold brew process options for a user to order and pay for a cold brew beverage.

The cold brew apparatus 100 may further include one or more dispensing spouts 108(1) and 108(2) (or taps). The one or more dispensing spouts 108(1) and 108(2) may include a lever that, when actuated, dispenses fluid (cold brew). In an embodiment, a first spout 108(1) may dispense cold brew coffee at a cold temperature. A second spout 108(2) may dispense nitrogenized cold brew coffee. For example, the cold brew apparatus 100 may include conduit that is in fluid communication with one or more gas storage vessels containing nitrogen, for example. The conduit from the gas storage vessels may converge with conduit carrying the cold brew coffee to the second spout 108(2). While described above as dispensing “nitrogenized” cold brew, the cold brew apparatus 100 may dispense cold brew coffee being mixed with any type of food grade gas. In an embodiment, the gas storage vessel may be included in the cold brew apparatus 100. Additionally, and/or alternatively, the gas storage vessel may be external to the cold brew apparatus 100.

The cold brew apparatus 100 also includes hook-up(s) and conduit(s) to attach the cold brew apparatus 100 to a source of water (and/or other fluids). Moreover, in an embodiment, the second spout 108(2) may dispense a cold brew mixed with other non-gaseous drink additives. That is, the conduit carrying the liquid for dispensing to the second spout 108(2) may converge with a conduit carrying a different drink additive (e.g., cocoa, flavored syrups, milk, non-dairy milk, etc.). In an embodiment, a user may select a specific additive to be mixed with the cold brew coffee. In such an embodiment, when the user dispenses the cold brew, the additive may automatically mix with the cold brew in the conduit prior to dispensing.

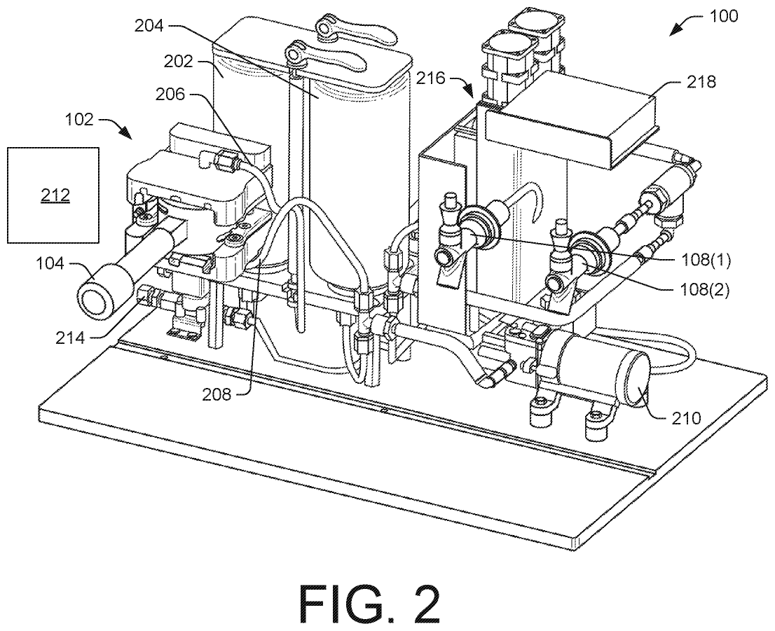

FIG. 2 illustrates a perspective view of the cold brew apparatus 100 with the housing removed, thereby showing at least some, possible, internal components of the cold brew apparatus 100. As shown in FIG. 2, the cold brew apparatus 100 may include a first vessel 202 and a second vessel 204. While describing two vessels, it is to be understood that the cold brew apparatus 100 may include less than two vessels or more than two vessels. The first vessel 202 and the second vessel 204 may be in fluid communication with the group head 102. For example, the cold brew apparatus 100 may include conduit 206 between the first vessel 202 and the group head 102. In an embodiment, the conduit 206 between the first vessel 202 and the group head 102 may include a fluid inlet conduit into the group head 102. Furthermore, the cold brew apparatus 100 may include conduit 208 between the group head 102 and the second vessel 204. In an embodiment, the conduit 208 between the group head 102 and the second vessel 204 may include fluid outlet conduit from the group head. The first vessel 202 and the second vessel 204 may further be in fluid communication with one another.

The cold brew apparatus 100 may further include a pump 210. In an embodiment, the pump 210 may be in fluid communication with the group head 102, the first vessel 202, the second vessel 204, and/or other components described herein. The pump 210 may include a positive displacement pump, positive pressure pump, air diaphragm pump, centrifugal pump, etc. The pump 210 may transfer fluid from one or more components to dispense fluid out of the cold brew apparatus 100. For example, the pump 210 may transfer the cold brew from the first vessel 202 and/or the second vessel 204 and pump cold brew to be dispensed out of the first spout 108(1) and/or the second spout 108(2) via a positive pressure pump. In an alternative embodiment, it is contemplated that the pump 210 might also be connected in a way to draw fluid (water or cold brew) through the portafilter and into the first vessel 202 and/or second vessel 204 under vacuum.

Furthermore, the cold brew apparatus 100 may include more than one pump. For example, the cold brew apparatus 100 may include a vacuum pump 212. In an embodiment, the vacuum pump 212 may be included as part of the cold brew apparatus 100 or may be on site already, for example located beneath a counter or otherwise nearby the location of the apparatus 100, from which position the vacuum pump 212 may be attached via vacuum inlets 214 to the cold brew apparatus 100.

Inasmuch as the pump 210 and the vacuum pump 212 are pumping liquid for human consumption in the cold brew apparatus 100, pump 210 and vacuum pump 212 are food grade pump(s). In an example process, the vacuum pump 212 may pull fluid under vacuum through at least a portion of a fluid cycle including flowing cold brew from the first vessel, through the group head and the portafilter, and into the second vessel. While describing the vacuum pump 212 as completing the fluid cycle, it is contemplated other pump configurations may be applied in which a single pump may complete a full fluid cycle.

As described previously, the first vessel 202 and the second vessel 204 may be in fluid communication with one another. Thus, the cold brew apparatus 100 may complete multiple fluid cycles prior to dispensing. That is to say, once the cold brew apparatus 100 has completed a fluid cycle from the first vessel, through the group head and the portafilter, and into the second vessel, the cold brew apparatus 100 may pump the fluid back into the first vessel 202. Then when the now cold brew is back in the first vessel 202, the cold brew apparatus 100 may complete additional fluid cycles.

In an embodiment, a user of the cold brew apparatus 100 may be able to select a quantity of fluid cycles to be completed via a selectable control. In such an embodiment, the cold brew apparatus 100 may automatically complete the quantity of fluid cycles prior to dispensing the cold brew coffee. For example, a barista (or a home user) may desire to make a cold brew coffee having a specific strength. The barista may then select a quantity of cycles to be completed in order for the cold brew apparatus 100 to brew the cold brew at the desired strength. While describing the optional cycles as being potentially unlimited, it is understood that flavor may be significantly affected sufficiently for most users—before the taste of the cold brew is too strong—at about between 1 cycle and 3 cycles or between about 1 cycle and 5 cycles. Nevertheless, the cold brew apparatus 100 may be able to complete any quantity of cycles and/or portions thereof within the limitations of the durability of the components of the machine. In an embodiment where the cold brew apparatus 100 includes one vessel, the fluid may flow back into the vessel after flowing through the group head and portafilter.

The cold brew apparatus 100 may further include a refrigeration unit 216. The refrigeration unit 216 may reduce a temperature of the fluid either prior to the brewing fluid cycle or after the fluid cycle and prior to dispensing. Additionally, and/or alternatively, the refrigeration unit 216 may reduce the temperature of the fluid before and after the brewing fluid cycle. In an embodiment, the cold brew apparatus 100 may include an external refrigeration unit instead of or in addition to the refrigeration unit 216. In such an embodiment, the external refrigeration unit may reduce the temperate of fluid prior to entering the cold brew apparatus 100. The cold brew apparatus 100 includes a power unit 218 that provides power to the cold brew apparatus 100 and/or the one or more computing devices (and other components).

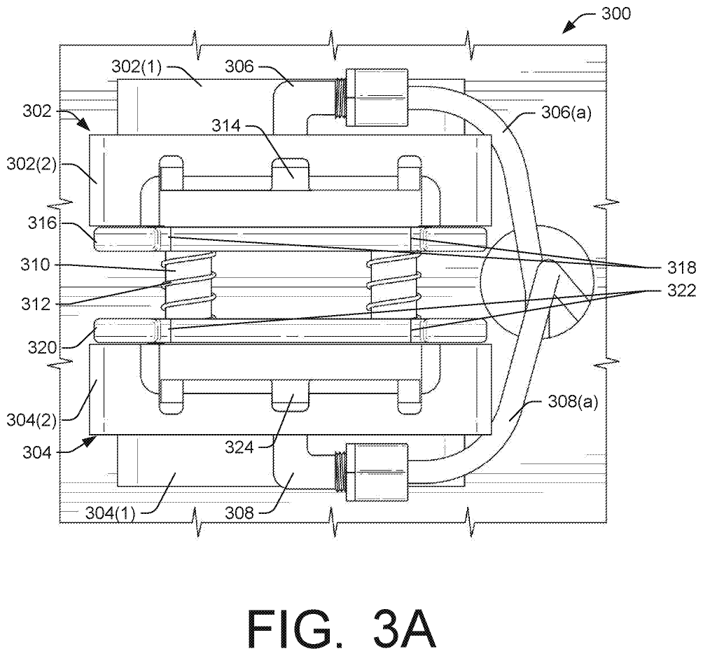

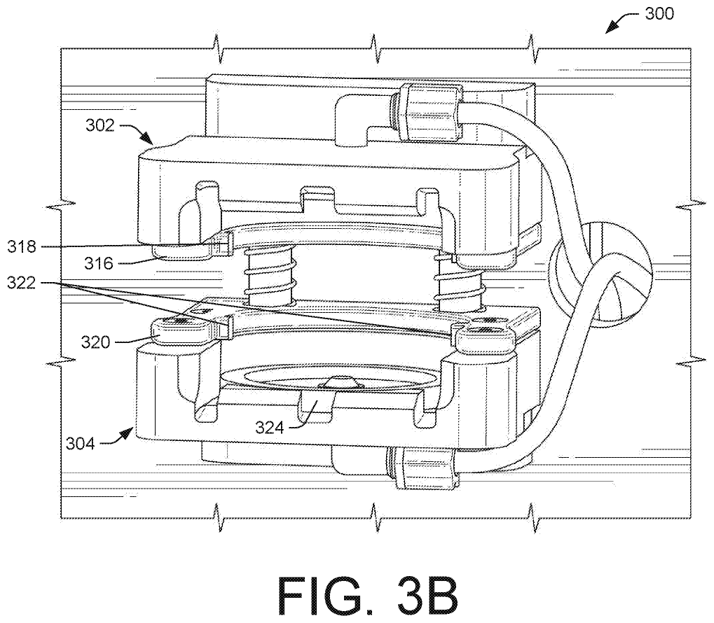

FIG. 3A illustrates a front view of a group head 300 of a cold brew apparatus as described above with respect to FIGS. 1 and 2. As shown in FIG. 3A, the group head 300 may include an upper portion 302 and a lower portion 304, the lower portion 304 being spaced a vertical distance below the upper portion 302. In an embodiment, the upper portion 302 and the lower portion 304 may be substantially similar, as in symmetrically opposing structures. For example, the upper portion 302 and the lower portion 304 may be a same piece flipped vertically. As described previously, the group head 300 may include a fluid inlet 306 with conduit 306(a) attached thereto to permit flow of fluid into the group head 300 via the upper portion 302 of the group head 300. Furthermore, the group head 300 may include a fluid outlet 308 with conduit attached thereto 308(a) to permit flow of fluid out of the group head 300 via the lower portion 304 of the group head 300. In an embodiment, both the upper portion 302 and the lower portion 304 of the group head are moveable. Additionally, and/or alternatively, one or the other of the upper portion 302 and the lower portion 304 is moveable. For example, the upper portion 302 of the group head 300 may be entirely stationary while the lower portion 304 of the group head 300 may be at least partially moveable, or vice versa.

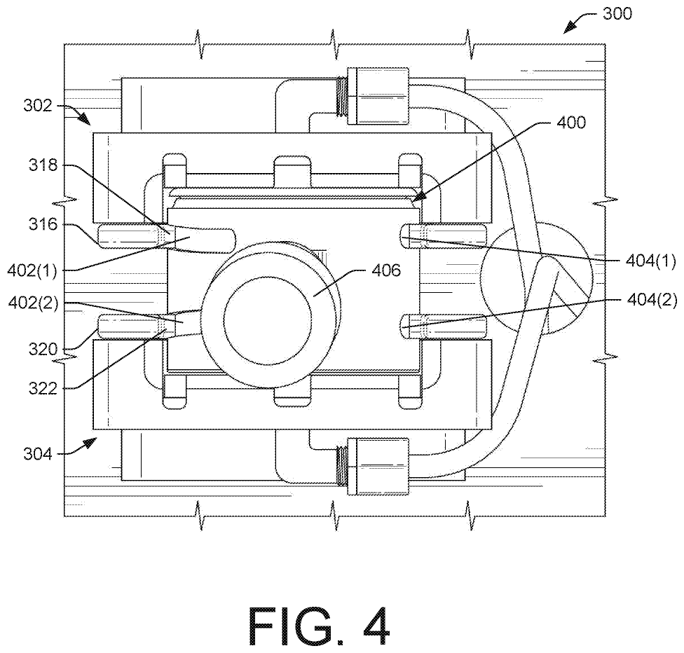

In an embodiment, the upper portion 302 of the group head 300 may include a stationary portion 302(1) and a moveable portion 302(2). The stationary portion 302(1) may be attached to the housing of the cold brew apparatus. The moveable portion 302(2) may slide vertically along one or more rods 310 of the group head 300. In an embodiment, the group head 300 may include one or more springs 312 disposed on the rods 310. The one or more springs 312 maintain an open position (as shown in FIG. 3) of the group head 300 until a force pulls (or compresses) the upper portion 302 and the lower portion 304 of the group head 300 towards one another. The upper portion 302 of the group head 300 may further include an O-ring 314 disposed on an inside portion of the upper portion 302, the O-ring 314 being located such that the O-ring 314 contacts a top portion of a portafilter when the portafilter is inserted into the opening of the group head 300. The upper portion 302 of the group head 300 may further include a bracket 316 attached to the moveable portion 302(2) of the upper portion 302. The bracket 316 may include one or more tabs 318 that are shaped to correspond with one or more grooves on the portafilter (described further herein below with respect to FIG. 4).

Since the lower portion 304 of the group head 300 may be the same as the upper portion 302, the lower portion 304 may include all of the same components as the upper portion 302 of the group head 300. For example, the lower portion 304 of the group head 300 may also include a stationary portion 304(1) and a moveable portion 304(2). The stationary portion 304(1) of the lower portion 304 being attached to the housing and the moveable portion 304(2) of the lower portion 304 sliding along the rods 310. The lower portion 304 of the group head 300 may also include a bracket 320 attached thereto, the bracket 320 having one or more tabs 322 shaped to engage one or more grooves of the portafilter. The lower portion 304 of the group head 300 may further include an O-ring 324 disposed on an inside portion of the lower portion 304, the O-ring 324 being located such that the O-ring 324 contacts a bottom portion of the portafilter when the portafilter is inserted into the opening of the group head 300. The group head 300 may further include a light to illuminate the group head 300 and the portafilter.

FIG. 3B illustrates a perspective view of the group head 300 described in FIG. 3A. As described above, FIG. 3B shows the bracket 316 disposed on the upper portion 302 including at least one tab 318. While not entirely shown in FIG. 3B due to the perspective, the bracket 316 of the upper portion 302 may also include another tab opposite the at least one tab 318. The bracket 320 disposed on the lower portion 304 may also include one or more tabs 322 shaped to engage one or more grooves of the portafilter, as seen in FIG. 3B. FIG. 3B also depicts an alternate view of the O-ring 324 described above with respect to FIG. 3A. As described previously, the O-ring 314 disposed on the upper portion 302 may be disposed in a similar location on the upper portion 302 as the O-ring 324 disposed on the lower portion 304.

FIG. 4 illustrates a front view of the group head 300 described in FIGS. 3A and 3B with a portafilter 400 held therein. For example, the upper portion 302 and the lower portion 304 may be spaced apart in an open position (shown in FIG. 3) such that the portafilter 400 engages the group head 300 between the upper portion 302 and the lower portion 304. Additionally, and/or alternatively, the group head 300 may be held at least partially closed by one or more springs when no portafilter is present within the opening of the group head. In such an embodiment, the one or more springs may allow the portafilter to open the group head far enough for the portafilter to be inserted into the group head. Once completely in the group head, the one or more springs (or other mechanism) may act on the group head sealing the portafilter in place. As shown in FIG. 4, the portafilter 400 includes multiple grooves etched (or cut, molded, etc.) in a body of the portafilter 400. More specifically, the portafilter 400 may include two sets of grooves, a first set 402(1) and 402(2) on a left-hand side of the portafilter 400 and a second set 404(1) and 404(2) on a right-hand side of the portafilter 400. Furthermore, the first set of grooves 402(1) and 402(2) may include a top groove 404(1) that corresponds with the upper portion 302 of the group head 300 and the first set of grooves 402(1) and 402(2) may include a bottom groove 402(2) that corresponds with the lower portion 304 of the group head 300. For example, a tab 318 of the bracket 316 attached to the upper portion 302 of the group head 300 may engage the top groove 402(1) of the portafilter 400. A tab 322 of the bracket 320 attached to the lower portion 304 of the group head 300 may engage the bottom groove 402(2) of the portafilter.

As shown in FIG. 4, the grooves 402(1), 402(2), 404(1), and 404(2) in the portafilter 400 may be shaped so as to allow the portafilter 400 to rotate in a single direction. That is to say, as depicted in FIG. 4, a handle 406 of the portafilter 400 may be rotated to the left. Additionally, and/or alternatively, the grooves 402(1), 402(2), 404(1), and 404(2) in the portafilter 400 may be shaped so as to allow multiple directions of rotation. As further shown in FIG. 4, the grooves 402(1), 402(2), 404(1), and 404(2) are shaped and angled along the side of the portafilter 400 such that, when the portafilter 400 is rotated to the left (into a “locked position”), the grooves 402(1), 402(2), 404(1), and 404(2) pull the upper portion 302 and the lower portion 304 of the group head 300 towards one another, thereby sealing the upper portion 302 and the lower portion 304 of the group head 300 on the corresponding sides of the portafilter 400. In an embodiment, when the portafilter 400 is in a locked position, the group head 300 may form an airtight seal on the portafilter 400. Such an airtight seal may allow the pump described above to create a vacuum in the portafilter between the upper portion 302 and the lower portion 304 of the group head 300. Thereby, the pump may pull fluid through the group head 300 and portafilter 400 under a vacuum to brew the cold brew coffee.

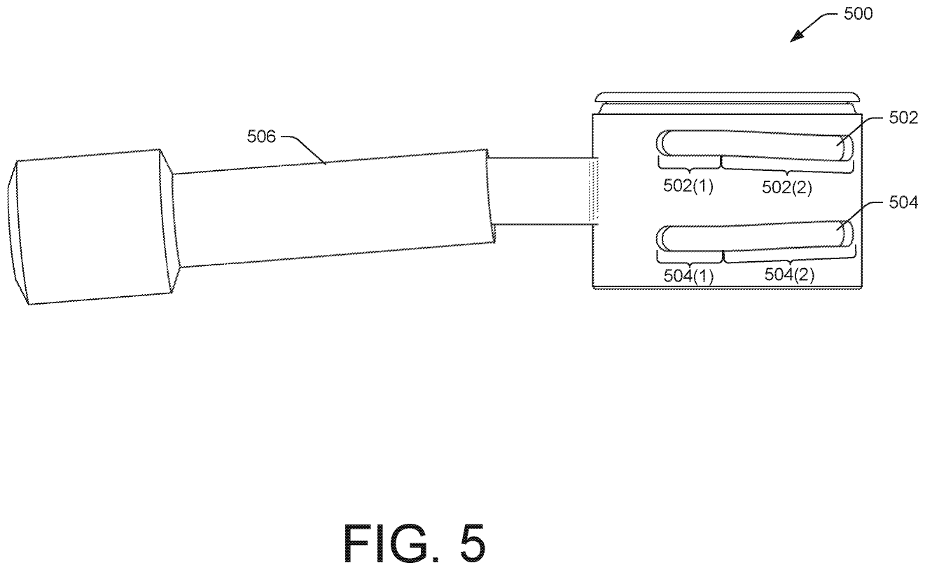

FIG. 5 illustrates a side view of a portafilter 500 of a cold brew apparatus. As described previously, the portafilter 500 may include multiple grooves 502 and 504 and/or multiple sets of grooves. For illustration purposes, FIG. 5 shows one set of grooves in order to depict a possible relation of one groove to another. For example, the portafilter 500 shown in FIG. 5 includes a first groove 502 that corresponds in position so as to align with an upper portion of a group head (as described previously). The portafilter 500 also includes a second groove 504 that corresponds in position so as to align with a lower portion of the group head. In an embodiment, the first groove 502 may include a first portion 502(1) and a second portion 502(2); and the second groove 504 may also include a first portion 504(1) and a second portion 504(2). As shown in FIG. 5, the first portion 502(1) of the first groove 502 and the first portion 504(1) of the second groove 504 may extend in a substantially parallel direction, while the second portion 502(2) of the first groove 502 and the second portion 504(2) of the second groove 504 may extend toward one another (such that they each extend in a direction that is convergent with one another).

While FIG. 5 illustrates one configuration of the grooves 502 and 504, other groove configurations are contemplated that would engage with the group head in order to create a seal around the portafilter 500. For example, the entire length of the grooves could be slanted. Additionally, and/or alternatively, the grooves may be shorter or longer than what is shown in FIG. 5. Furthermore, while describing multiple sets of grooves, the portafilter 500 may optionally include one set of grooves. Furthermore, the portafilter 500 may optionally lock into the group head with a hinging motion. In an embodiment, the portafilter 500 may include tabs shaped to engage with state of the art coffee grinders. In such an embodiment, the group head may include spaces for the tabs on the portafilter 500 to pass without inhibiting the rotational motion of the portafilter 500. Furthermore, the portafilter further includes a handle 506. The handle 506 may be designed and/or shaped based on a specific user's/purchaser's desire. The portafilter 500 may further include an attachment and/or dose basket that blocks flow of fluid therethrough in order to reverse flush the group head to clean the group head. In an embodiment, a cold brew apparatus may include a portafilter configured specifically to reverse flush the system of the cold brew apparatus. Furthermore, the portafilter 500 may include a dose basket and a secondary filter in order to catch solids that may pass through the dose basket.

FIG. 6 illustrates an example computing device 600 that may be included in a cold brew apparatus. While describing a single computing device, the cold brew apparatus may include multiple computing devices. The computing device may be communicatively coupled to a controller 602. In an embodiment, the controller 602 may control the fluid cycle of the cold brew apparatus as described above. For example, the controller 602 may control the number of fluid cycles that are to be completed prior to dispensing the cold brew coffee. In an embodiment, the controller 602 may be included in the cold brew apparatus, while the computing device is remote from the cold brew apparatus. The computing device 600 includes one or more processors 604 and memory 606. The memory 604 may store multiple fluid cycle procedures 608(1), 608(2), 608(3), . . . 608(N) (collectively “fluid cycle procedures 608”) which may be executed by the one or more processors 604. Each of the fluid cycle procedures 608 includes a set of instructions to cause the various components of the cold brew apparatus to perform operations to cycle fluid therethrough to brew cold brew coffee. For example, fluid cycle procedure 608(1) may be used to brew cold brew with two full fluid cycles. Further, fluid cycle procedure 608(2) may be used to cycle fluid to clean the cold brew apparatus, while fluid cycle procedure 608(3) may be used to nitrogenize the cold brew coffee prior to dispensing. The computing device may include one or more input/output components 610 through which a user/operator may interact with the computing device 600. By way of example and not limitation, the input/output component(s) 610 of the computing device 600 may include a physical or graphical user interface (UI), keyboard, keypad, mouse, touch screen, camera, microphone, speakers, printer, scanner, switches, levers, or any other conventional input and/or output components. In an embodiment, the one or more input/output components may be disposed on the cold brew apparatus, while the computing device 600 is remote from the cold brew apparatus.

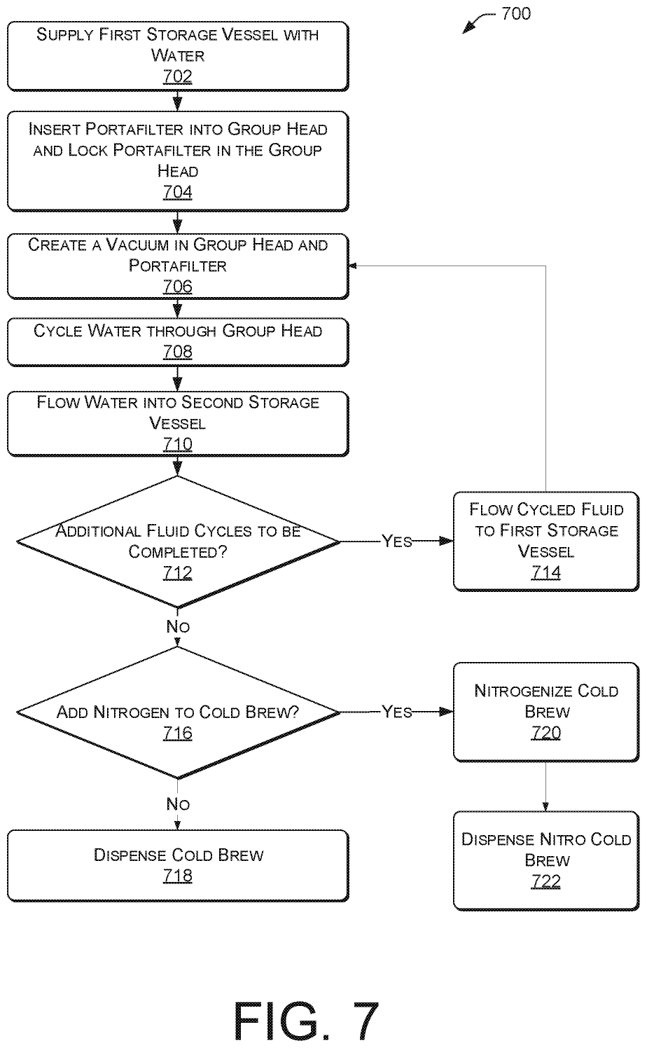

FIG. 7 depicts a flow diagram of an example fluid cycle process 700 for brewing cold brew coffee in a cold brew apparatus as described above with respect to FIGS. 1-5. For ease of explanation, the process 700 is described as being performed at least in part by the cold brew apparatus 100. However, in alternative embodiments, the example fluid cycle process 700 may be performed by other cold brew apparatuses. Furthermore, in an embodiment, a human operator may complete any or all of the steps described in the example fluid cycle process 700. Still further, the example fluid cycle process 700 may be entirely automated, such as in a vending machine or other automated machine.

The example fluid cycle process 700 (as well as each process described herein) is illustrated as a logical flow graph, each operation of which represents a sequence of operations that can be implemented by hardware, software, human operators, or a combination thereof. In the context of software, the operations represent computer-executable instruction stored on one or more computer-readable media that, when executed by one or more processors, perform the recited operations. Generally, computer-executable instructions include routines, programs, objects, components, data structures, and the like that perform particular functions or implement particular abstract data types.

The computer-readable media may include non-transitory computer readable storage media, which may include hard drives, floppy diskettes, optical disks, CD-ROMs, DVDs, read-only memories (ROMs), random access memories (RAMs), EPROMS, EEPROMS, flash memory, magnetic or optical cards, solid-state memory devices, or other types of storage media suitable for storing electronic instructions. In addition, in some embodiments the computer-readable media may include a transitory computer-readable signal (in compressed or uncompressed form). Examples of computer-readable signals, whether modulated using a carrier or not, include, but are not limited to, signals that a computer system hosting or running a computer program can be configured to access, including signals downloaded through the Internet or other networks. Finally, unless otherwise noted, the order in which the operations are described is not intended to be construed as a limitation, and any number of the described operations can be combined in any order and/or in parallel to implement the process.

At 702, the first storage vessel is supplied with fresh water (or other fluid). In an embodiment, an operator may select an input control that instructs a computing device to allow water to enter the first storage vessel. However, in an alternative embodiment, the computing device may automatically fill the first storage vessel with water when the cold brew apparatus is connected to a water source.

At 704, a portafilter holding coffee grounds (or tea/other brewable) is inserted into a group head and the portafilter is locked in the group head. In an embodiment, the group head may automatically lock down onto the portafilter when the portafilter is inserted into the group head. As described previously, when in a locked position, the group head may form an airtight seal around the portafilter.

At 706, the cold brew apparatus may create a vacuum in the group head and the portafilter. The vacuum is created by a pump that is in fluid communication with the group head and the portafilter.

At 708, the cold brew apparatus may cycle water through the group head. For example, the pump of the apparatus may draw fluid from the first storage vessel into the group head and portafilter.

At step 710, once the fluid is drawn through the portafilter, the pump may cycle fluid from the group head into a second storage vessel. In an embodiment where the cold brew apparatus has only a single storage vessel, the cold brew apparatus will flow the fluid back into the sole storage vessel.

At 712, the cold brew apparatus may determine whether additional fluid cycles are to be completed. If, at 712, it is determined that additional fluid cycles are to be completed, the cold brew apparatus flows fluid from the second storage vessel, back into the first storage vessel at 714, or into the sole vessel, if so equipped. The process may then begin again at 706. The additional cycles do not necessitate a new portafilter with fresh grounds to be inserted into the cold brew apparatus.

If instead, at 712, it is determined that no additional fluid cycles are needed, the process may continue to 716 in embodiments where nitrogenization (or other gasification) is an incorporated feature and available at the time of the cycle. At 716, the cold brew apparatus may determine whether the cold brew coffee is to be nitrogenized (or infused with another gas).

At 716, if it is determined that the cold brew coffee is not to be nitrogenized, the process proceeds to step 718 and the cold brew apparatus (or an operator, in the event the embodiment is manually dispensed) will dispense the cold brew out of the cold brew apparatus.

If instead, at 716, if it is determined that the cold brew is to be nitrogenized, the process proceeds to step 720 and the cold brew apparatus will nitrogenize the cold brew. Once the cold brew is nitrogenized, at 722, the cold brew will be dispensed out of the cold brew apparatus.

### CONCLUSION

While various examples and embodiments are described individually herein, the examples and embodiments may be combined, rearranged, and modified to arrive at other variations within the scope of this disclosure.

Although embodiments have been described in language specific to structural features and/or methodological acts, it is to be understood that the disclosure is not necessarily limited to the specific features or acts described. Rather, the specific features and acts are disclosed herein as illustrative forms of implementing the claimed subject matter.

What is claimed is:

1. A brewing apparatus, comprising:
a group head;
a portafilter shaped to engage with the group head such that the group head forms a seal on the portafilter when the portafilter is in a locked position;
a first vessel in fluid communication with the group head;
a second vessel in fluid communication with the group head; and
a vacuum pump connected to the first vessel and the second vessel to pump fluid from the first vessel through the group head and the portafilter into the second vessel.

2. The brewing apparatus of claim 1, wherein the group head includes an upper portion and a lower portion, wherein the lower portion is spaced a vertical distance below the upper portion and the portafilter engages the group head between the upper portion and the lower portion.

3. The brewing apparatus of claim 2, wherein at least the lower portion of the group head moves to seal the portafilter between the upper portion of the group head and the lower portion of the group head when the portafilter engages the group head.

4. The brewing apparatus of claim 1, wherein the portafilter includes one or more grooves to engage with correspondingly shaped tabs on the group head.

5. The brewing apparatus of claim 4, wherein the one or more grooves are shaped such that the portafilter is rotatable in at least one direction to lock the portafilter in the group head.

6. The brewing apparatus of claim 1, further comprising:
a first dispensing spout in fluid communication with the second vessel, the dispensing spout including a lever that, when actuated, dispenses fluid from the second vessel; and
a second dispensing spout in fluid communication with the second vessel and a gas storage tank, wherein the fluid is mixed with gas from the gas storage tank prior to dispensing out of the second dispensing spout.

7. The brewing apparatus of claim 4, wherein the one or more grooves of the portafilter include:
a first groove having a first portion and a second portion, and
a second groove having a first portion and a second portion,
wherein the first portion of the first groove and the first portion of the second groove extend in a substantially parallel direction, and
the second portion of the first groove and the second portion of the second groove extend towards one another.

8. The brewing apparatus of claim 1, wherein the portafilter includes a dose basket to hold coffee grounds and a secondary filter disposed beneath the dose basket.

9. A cold brew apparatus, comprising:
a group head including an upper portion and a lower portion spaced a vertical distance from the upper portion, at least the lower portion being movable in a vertical direction;
a portafilter sized to be inserted between the upper portion and the lower portion of the group head, the group head creating an airtight seal around the portafilter when the portafilter is in a locked position within the group head;
a fluid inlet conduit attached to, and in fluid communication with, the upper portion of the group head, the fluid inlet conduit permitting fluid to flow into the upper portion of the group head before flowing into the portafilter;
a fluid outlet conduit attached to, and in fluid communication with, the lower portion of the group head, the fluid outlet conduit permitting the fluid out of the portafilter and into the lower portion of the group head; and
a vacuum pump in fluid communication with at least the fluid outlet conduit, the vacuum pump creating a vacuum in the group head and in the portafilter when the portafilter is locked in the group head, and the vacuum pump drawing the fluid from the fluid inlet conduit, through the group head and the portafilter, and through the fluid outlet conduit.

10. The apparatus of claim 9, further comprising:
a first vessel in fluid communication with the group head via the fluid inlet conduit; and
a second vessel in fluid communication with the group head via the fluid outlet conduit,
wherein the first vessel and the second vessel are in fluid communication with one another.

11. The apparatus of claim 10, wherein a fluid cycle of the apparatus includes the fluid flowing from the first vessel through the group head and portafilter, into the second vessel, and back into the first vessel, and
wherein the apparatus further includes a selectable control to control a quantity of fluid cycles prior to dispensing the fluid.

12. The apparatus of claim 9, wherein the portafilter includes:
a first groove corresponding in position on the portafilter so as to align with the upper portion of the group head, and
a second groove corresponding in position on the portafilter so as to align with the lower portion of the group head.

13. The apparatus of claim 12, wherein the first groove and the second groove are oriented such that when the portafilter is rotated within the group head, the upper portion of the group head and the lower portion of the group head are drawn towards one another to create the airtight seal on the portafilter.

14. The apparatus of claim 9, further comprising a dispensing tap in fluid communication with the second vessel.

15. A cold brew coffee apparatus, comprising:
a group head;
a portafilter that is insertable into the group head;
a first fluid conduit attached to the group head to permit flow of a fluid into the group head;
a second fluid conduit attached to the group head to permit flow of the fluid out of the group head; and
a pump configured to create a vacuum in the group head and draw fluid from the first fluid conduit, through the group head and portafilter, and into the second fluid conduit.

16. The apparatus of claim 15, wherein the group head includes an upper portion and a lower portion, and
wherein both the upper portion and the lower portion are moveable.

17. The apparatus of claim 16, wherein the portafilter includes grooves that correspond with each of the upper portion and the lower portion, the grooves being oriented such that when the portafilter is rotated within the group head, the grooves draw the upper portion and the lower portion of the group head towards one another creating a seal around the portafilter.

18. The apparatus of claim 15, further comprising one or more fluid storage vessels in fluid communication with the group head.

19. The apparatus of claim 18, further comprising a controller configured to execute a fluid cycle one or more times, the fluid cycle cycling fluid from one or more fluid storage vessels, into the first fluid conduit, through the group head and portafilter, through the second fluid conduit, and into the one or more fluid storage vessels.

20. The apparatus of claim 18, further comprising one or more dispensing taps in fluid communication with the one or more fluid storage vessels.
